(19) United States
(12) Patent Application Publication
(10) Pub. No.: US 2007/0252548 A1
(43) Pub. Date: Nov. 1, 2007

(54) Method of protecting power device of inverter during stall of motor

(76) Inventors: Sang-Hyeon Moon, Hwaseong-si (KR); Hyung-Bin Ihm, Hwaseong-si (KR)

Correspondence Address: MORGAN, LEWIS & BOCKIUS LLP (SF), 2 PALO ALTO SQUARE, 3000 El Camino Real, Suite 700, PALO ALTO, CA, 94306, US

(21) Appl. No.: 11/648,815

(22) Filed: Dec. 28, 2006

(30) Foreign Application Priority Data
Apr. 28, 2006 (KR) 10-2006-0038792

(51) Int. Cl. H02P 7/00

(52) U.S. Cl. 318/434

(57) ABSTRACT

A method of protecting a power device of an inverter from overheating when a motor stalls or is operated in a low-speed range, including detecting and then performing an operation on a maximum tolerable temperature at a junction of the power device of the inverter and a casing temperature between the power device and a radiating plate, calculating an absolute value of an operating speed, and applying a pattern gain differently depending on the calculated absolute value, calculating inverter loss resulting from input motor torque and speed of the motor, performing an operation on the values calculated and calculating a difference between the temperature at the junction of the power device of the inverter and the casing temperature, limiting output of a PI controller that receives the temperature difference calculated, and limiting operational torque output of the motor according to the input motor torque command using the output of the PI controller.

### CROSS-REFERENCE TO RELATED APPLICATIONS

The present application is based on, and claims priority from, Korean Application Serial Number 10-2006-0038792, filed on Apr. 28, 2006, the disclosure of which is hereby incorporated by reference herein in its entirety.

### FIELD OF THE INVENTION

The present invention relates to a method of protecting the power device of an inverter when a motor stalls, and, more particularly, to a method of protecting the power device of an inverter from overheating by limiting the motor torque that can be output when a motor stalls or is operated in a low-speed range.

### BACKGROUND OF THE INVENTION

Generally, an inverter is a device for generating three-phase alternating current (AC) from a direct current (DC) power supply of variable voltage/variable frequency and then operating an AC motor or other load. The power device functions as a switch in the inverter, and may be used in full-bridge form. When the inverter is operated, heat is generated from the power device therein. If the temperature at the junction of the power device exceeds a temperature limit, the life-cycle is shortened and the power device can be damaged, thus an appropriate radiator structure is required.

Such a radiator structure is typically designed to withstand temporary and continuous rated loads. Designing such a radiator structure is based on an assumption that the heating values of the power device are uniform in respective phases (U, V and W) (see FIG. 1(a)). However, when the motor stalls or is operated in a low-speed range, variation occurs between heating values for respective phases. In particular, when the motor stalls, in the worst case, a heating value in one phase may be two times as much as the value in the case in which the heating values in respective phases are uniform. In this case, when the temperature at the junction exceeds a tolerable limit, damage to the power device is caused by overheating.

In other words, The radiator structure of the inverter has equal heating value for respective phases when the motor is operated normally (see FIG. 1(b)) but the heating is concentrated on one of the phases when the motor stalls (see FIG. 1(c)). Therefore, the radiator structure of the inverter does not avoid overheating to an individual phase when the motor stalls or is operated in the low-speed range. If the temperature at the junction of the individual phase exceeds a boundary condition of the temperature at the junction, the radiator structure of the inverter is damaged.

For this purpose, in order to protect the power device of an inverter from being overloaded when the motor stalls, as illustrated in FIG. 1b, there is a method in which a sensor is mounted on the casing Tc of the power device and the radiating plate Ts, and then temperature is measured. The measured temperature is added to an estimated value for the temperature increase occurring due to an applied load, thereby calculating the temperature at the junction of the power device. When the calculated temperature exceeds a predetermined temperature, a decrease rate is determined according to a predetermined output decrease pattern (see FIG. 1(d)), and is multiplied by a torque command Trq*, thereby protecting the power device from overheat due to overload (see FIG. 1(e)). For reference, in FIG. 1(f), reference character ‘Tc’ refers to a casing temperature.

However, the conventional method of protecting the power device of an inverter from overheating using the output decrease pattern has problems in that there is imbalance between temperatures of respective phases of the power device when a motor stalls or is operated in a low-speed range, and the power device may be damaged by a fire when the temperature in any one phase exceeds a tolerable limit.

### SUMMARY OF THE INVENTION

Embodiments of the present invention provide a method of protecting the power device in an inverter from overheating when a motor stalls, in which a PI controller receives a feedback value of the temperature difference between a junction and a casing, which is calculated as the product of a maximum inverter loss, which is calculated using the temperature difference between the temperature limit value of the power device and the casing temperature, and a thermal resistance, and in which an output torque is limited, in order to protect the power device of an inverter from overheating by limiting the torque that can be output when a motor stalls or is operated in a low-speed range.

An embodiment of the present invention provides a method of protecting a power device of an inverter includes the steps of a first step of detecting and then performing an operation on a maximum tolerable temperature at a junction of the power device of the inverter and a casing temperature between the power device and a radiating plate, according to motor operation, calculating an absolute value of an operating speed resulting from motor operation, and applying a pattern gain differently depending on the calculated absolute value; a second step of calculating a inverter loss resulting from a input motor torque command and a speed of the motor according to the motor operation; a third step of performing an operation on the values calculated at the first step and the second step and then calculating a difference between the temperature at the junction of the power device of the inverter and the casing temperature; a fourth step of limiting an output of a PI controller which receives the temperature difference calculated at the third step through feedback; and a fifth step of limiting an operational torque output of the motor according to the input motor torque command using the output of the PI controller at the fourth step.

### BRIEF DESCRIPTION OF THE DRAWINGS

For a better understanding of the nature and objects of the present invention, reference should be made to the following detailed description with the accompanying drawings, in which:

FIG. 1(a) is a diagram illustrating the structure of a conventional inverter;

FIG. 1(b) is a diagram illustrating a conventional heat distribution of a power device when a motor is operated normally,

FIG. 1(c) is a diagram illustrating a conventional heat distribution of the power device when a motor stalls or is operated in a low-speed range,

FIG. 1(d) is a diagram illustrating the radiating structure of the power device of the conventional inverter;

FIG. 1(e) is a diagram illustrating a conventional torque output decrease pattern for protecting the power device from overheating;

FIG. 1(f) is a diagram illustrating a conventional block for protecting the power device from overheating; and

FIG. 2 is a diagram illustrating a block for protecting the power device from overheating according to the present invention.

FIG. 3 is a flow chart illustrating for protecting the power device from overheating according to the present invention.

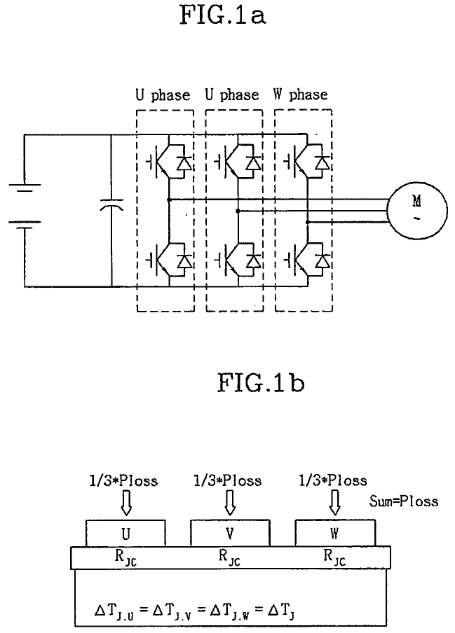

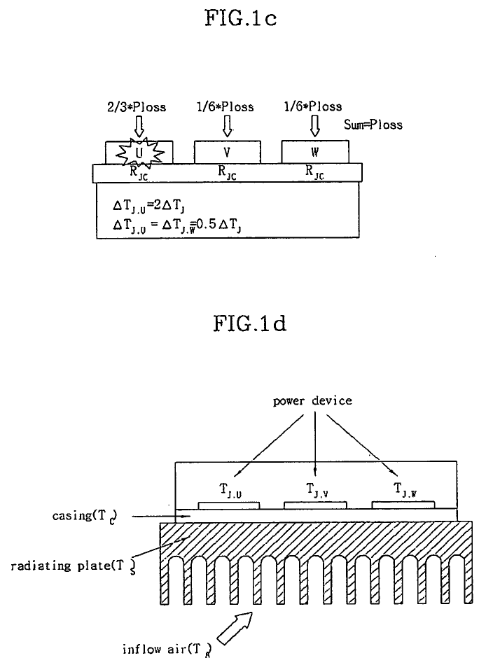

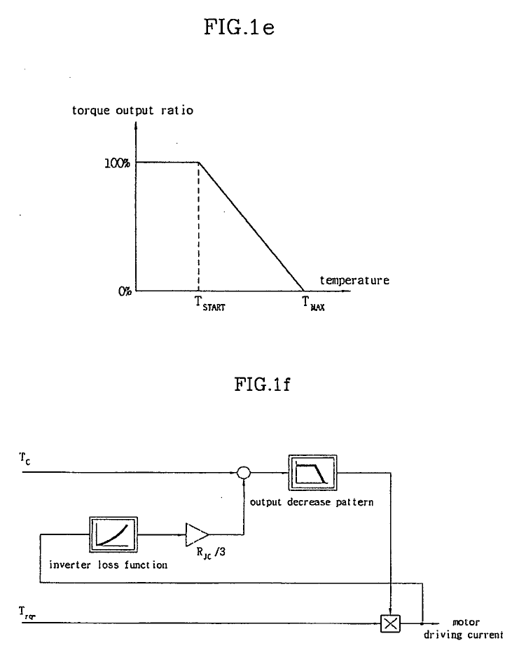

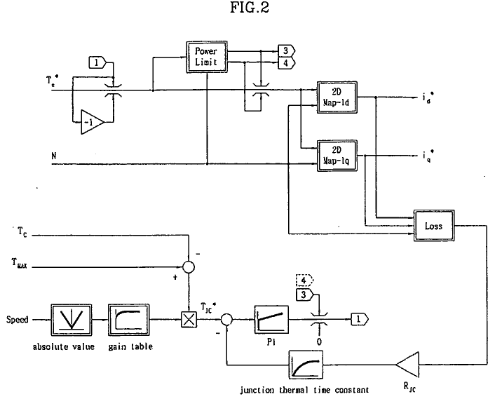

### DETAILED DESCRIPTION OF THE PREFERRED EMBODIMENTS

Exemplary embodiments of the present invention are described with reference to the accompanying drawings.

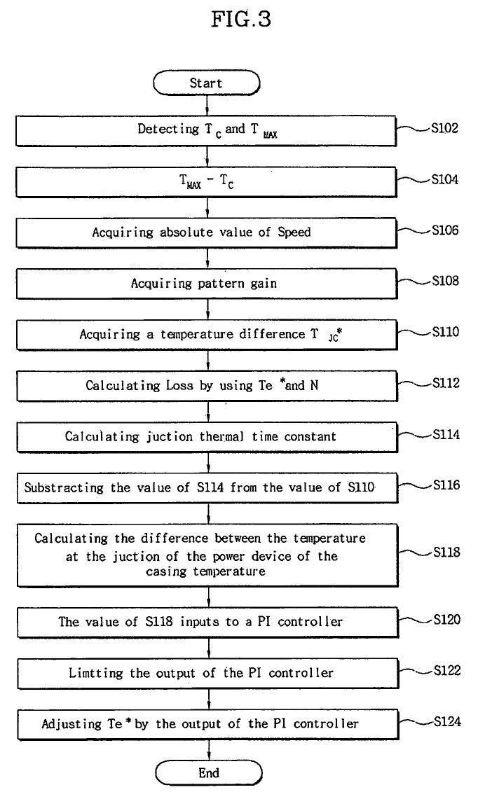

As illustrated in FIG. 2 and FIG. 3, an exemplary embodiment of the present invention detects operation at a maximum tolerable temperature Tmax at the junction of the power device of the inverter, and a casing temperature Tc between the power device and a radiating plate in order to protect the power device from overheating during operation of a motor. In particular, such protection can be important when the motor stalls or is operated in a low-speed range (S102). The casing temperature Tc between the power device and a radiating plate is subtracted from the maximum tolerable temperature Tmax at the junction of the power device of the inverter (S104).

Furthermore, the absolute value of the operating speed of the motor speed is acquired (S106), and then a pattern gain related thereto is calculated (S108). Depending on the operational state of the motor, as one, non-limiting example, the pattern gain is about 0.33 when the motor stalls, and the pattern gain is set to 1 when the motor is out of the low-speed range. Other values may be selected by persons of ordinary skill in the art based on the teachings herein.

After the pattern gain based on the operating speed of the motor has been calculated, a temperature difference Tjc* is acquired by performing an AND operation on the calculated temperature difference of the S104 and the calculated pattern gain from S108 (S110).

An inverter loss incurred by motor operation is calculated using current maps (S112); that is, 2D Map-ld and 2D Map-lq, respectively corresponding to the motor torque command Te* and the motor speed N. Then a junction thermal time constant is calculated by performing an AND operation on the calculated inverter loss and the thermal resistance Rjc of the power device (S114).

After the junction thermal time constant has been calculated, the junction thermal time constant is subtracted from the performing value S110 (S116). The difference between the temperature at the junction of the power device and the casing temperature is then calculated (S118).

After the calculated temperature difference has been input to a PI controller (S120), the output of the PI controller is limited depending on the calculated temperature difference (S122). That is, in an exemplary embodiment, when the output of the PI controller is limited, speed limitation is performed so that the motor is forced to operate lower than a predetermined rated speed by a power limiting unit when the motor operates at higher than the predetermined rated speed.

Limitation values 3 and 4, which enable the motor to operate at lower than the rated speed through the power limiting unit, are reflected in the output of the PI controller. Thereafter, the output 1 of the PI controller is reflected in the motor torque command Te*, which is input at S112, thereby adjusting the output torque (S124).

The PI controller may comprise a processor, memory and associated hardware and software as may be selected and programmed by a person of ordinary skill in the art based on the teachings of the present invention.

As described above, in the present invention, a logic operation is performed on the difference value between the tolerable temperature limit of the power device of the inverter and the casing temperature, and the junction thermal time constant obtained by performing an AND operation on the inverter loss and the thermal resistance, then the PI controller receives the result value through feedback and an input motor torque command is adjusted using an output torque value, thereby limiting a torque output for operation of the motor when the motor stalls or is operated in a low-speed range, thus preventing a power device from overheating.

The method of protecting the power device of an inverter when the motor stalls has the following advantages.

First, the power device of the inverter does not overheat when a motor stalls or is operated in a low-speed range, thereby preventing damage to the inverter.

Second, an expensive radiating structure design is made unnecessary, thereby reducing the manufacturing cost.

Third, maximum torque can be output within a tolerable temperature range during operation of the motor, thereby improving power performance.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A method of protecting a power device of an inverter from overheating when a motor stalls or is operated in a low-speed range, comprising:
detecting and then calculating a temperature difference between a maximum tolerable temperature at a junction of the power device of the inverter and a casing temperature between the power device and a radiating plate, according to motor operation, calculating an absolute value of an operating speed resulting from motor operation, and applying a pattern gain differently depending on the calculated absolute value;
calculating an inverter loss resulting from an input motor torque command and a speed of the motor according to the motor operation;
performing an operation on the values calculated at the first step and the second step and then calculating a difference between the temperature at the junction of the power device of the inverter and the casing temperature;
limiting an output of a PI controller which receives the temperature difference calculated at the third step through feedback; and
limiting an operational torque output of the motor according to the input motor torque command using the output of the PI controller at the fourth step.

2. The method as defined in claim 1, further comprising performing an operation on the temperature difference calculated at the first step and the absolute value of the operating speed of the motor.

3. The method as defined in claim 1 or 2, wherein, after the absolute value of the operating speed resulting from motor operation has been calculated, the pattern gain related thereto is calculated, the pattern gain when a motor stalls is set to be smaller than the pattern gain when the motor is out of a predetermined low-speed operation range.

4. The method as defined in claim 1, wherein, the inverter loss resulting from motor operation is calculated using current maps respectively corresponding to the input motor torque command and the speed of the motor at the second step.

5. The method as defined in claim 4, further comprising a step of calculating a junction thermal time constant at the junction of the power device by performing an AND operation on the calculated inverter loss and a thermal resistance of the power device.

6. The method as defined in claim 1, wherein the third step calculates a difference between the maximum tolerable temperature at the junction of the power device and the casing temperature between the power device and a radiating plate, performs an operation on the calculated temperature difference and the absolute value of the operating speed of the motor, in which a pattern gain is reflected, and then performs an operation on the calculated value and the junction thermal time constant, calculated using the inverter loss, thereby calculating the difference between the temperature at the junction of the power device of the inverter and the casing temperature.

7. The method as defined in claim 1, wherein limitation of the output of the PI controller at the fourth step is limitation of the operating speed within a predetermined rated speed the when the motor is operated at higher than the predetermined rated speed.
